(19) United States
(12) Patent Application Publication
(10) Pub. No.: US 2021/0187999 A1
(43) Pub. Date: Jun. 24, 2021

(54) BICYCLE RIM

(71) Applicant: TIEN HSIN INDUSTRIES CO., LTD., Taichung City (TW)

(72) Inventor: Ron Correa, Taichung City (TW)

(21) Appl. No.: 16/779,669

(22) Filed: Feb. 3, 2020

(30) Foreign Application Priority Data
Dec. 19, 2019 (TW) 108146695

(51) Int. Cl. B60B 21/10; B60B 21/08

(52) U.S. Cl. CPC B60B 21/104; B60B 1/003; B60B 2900/1216; B60B 21/08

(57) ABSTRACT

A rim includes a rim body and a spoiler portion. The rim body is annular and has two opposite side surfaces connected by an intermediate portion. Each surface has a radial inner portion located on a radial inner side and a radial outer portion located on a radial outer side. The radial outer portion has an extension portion and a radial outer periphery at the outermost side. The extension portion is extended toward the radial outer side from a connecting portion between the radial outer portion and the intermediate portion. The spoiler portion has a plurality of spoiler profiles concavely formed on the radial outer portion of at least one of the two side surfaces. At least one of the spoiler profiles is partially disposed on the extension portion without forming any undulation on the radial outer periphery.

### FIELD OF THE INVENTION

The present disclosure relates to a rim for a bicycle, and more particularly to a rim capable of decreasing wind resistance.

### BACKGROUND OF THE INVENTION

A design of a bicycle should consider a wind resistance effect when the bicycle is riding at high speed. A racing bicycle is usually designed to allow a rider to ride in a streamlined prone position. However, when a bicycle moves, wheels of the bicycle may suffer from wind resistance.

A wheel of a bicycle includes a rim and a tire secured to the rim. The rim for supporting the tire has two opposite side surfaces. In order to decrease a wind resistance of a fast turning wheel, each of the side surfaces is usually designed to be a smooth surface to decrease a cross sectional area of a windward surface thereof. However, when a wheel is turning, a laminar boundary layer may be formed on each of the smooth side surfaces of the wheel, and the laminar boundary layer may further develop into a turbulent flow when a vehicle speed gradually increases, thereby causing a resistance to the wheel turning.

In addition, for the requirements of bicycle speed races, a rim height of a bicycle rim increases with the increasing bicycle speed, therefore a larger side surface height of a rim is used by more and more rims, thereby making the aforementioned problem of turbulent more obvious.

### SUMMARY OF THE INVENTION

The present disclosure provides a rim, which has a spoiler portion to decrease a turbulent flow when a wheel of a bicycle is turning, thereby raising riding efficiency.

The present disclosure provides a rim applied to a bicycle, wherein the rim rotates about an axis and includes a rim body and a spoiler portion. The rim body is annular and has two opposite side surfaces. The two side surfaces are connected by an intermediate portion. Each of the side surfaces has a radial inner portion and a radial outer portion. The radial inner portion of one of the side surfaces is located on a radial inner side defined by a radial direction and gradually inclined toward the other side surface. The radial outer portion is located on a radial outer side defined by the radial direction. The radial outer portion has an extension portion and a radial outer periphery at the outermost side along the radial direction. The extension portion is extended toward the radial outer side from a connecting portion between the radial outer portion and the intermediate portion. The spoiler portion has a plurality of spoiler profiles. The plurality of spoiler profiles is concavely formed on the radial outer portion of at least one of the two side surfaces, and at least one of the plurality of spoiler profiles is partially disposed on the extension portion without forming any undulation on the radial outer periphery.

In an embodiment of the present disclosure, a brake surface is disposed on at least one of the two side surfaces, and the spoiler portion is disposed between the brake surface and the radial outer portion.

In an embodiment of the present disclosure, the plurality of spoiler profiles of the spoiler portion is regularly arranged as a plurality of spoiler profile groups.

In an embodiment of the present disclosure, each of the spoiler profile groups includes two first spoiler profiles respectively located at two ends, a second spoiler profile located in central and a plurality of third spoiler profiles located between the two first spoiler profiles and the second spoiler profile. Lengths of the third spoiler profiles are gradually changed from the two first spoiler profiles to the second spoiler profile.

In an embodiment of the present disclosure, the lengths of the third spoiler profiles are gradually increased from the two first spoiler profiles to the second spoiler profile.

In an embodiment of the present disclosure, the plurality of spoiler groups is arranged parallel to each other and spaced at an equal distance.

In an embodiment of the present disclosure, one of the two first spoiler profiles is respectively disposed on a main body of the extension portion, and the other one is disposed on a main body of the radial outer portion.

In an embodiment of the present disclosure, the adjacent spoiler profiles have unequal lengths.

In an embodiment of the present disclosure, distances between tops of the plurality of spoiler profiles and the radial outer portion are gradually increased in a rotating direction, and the rotating direction is a direction in which the rim drives the bicycle to move.

In an embodiment of the present disclosure, the plurality of spoiler profiles is distributed at equal distances on the radial outer portion.

In an embodiment of the present disclosure, each of the plurality of spoiler profiles has a first opening facing the extension portion and a second opening facing the radial inner portion, wherein a width of the first opening is greater than a width of the second opening.

In an embodiment of the present disclosure, a first side wall and a second side wall opposite to the first side wall are connected between the first opening and the second opening of each of the plurality of spoiler profiles, wherein an inclination of the first side wall is smaller than an inclination of the second side wall.

In an embodiment of the present disclosure, the first side wall has a first end on the first opening and a second end on the second opening. The second end is disposed behind the first end in a rotating direction, and the rotating direction is a direction in which the rim drives the bicycle to move.

In an embodiment of the present disclosure, the spoiler portion has a maximum depth not less than 0.25 mm and not greater than 4.5 mm.

In an embodiment of the present disclosure, the spoiler portion has a maximum radial length not less than 0.1 mm and not greater than 300 mm.

According to above description, since a spoiler portion is disposed on the side surfaces of the rim of the present disclosure, airflow can be guided by the spoiler portion when the wheel rotates to reduce the possibility that a laminar boundary layer develops into a turbulent flow and reduce the air resistance experienced by the wheels, thereby improving riding efficiency.

Other objectives, features and advantages of the invention will be further understood from the further technological features disclosed by the embodiments of the invention.

### BRIEF DESCRIPTION OF THE DRAWINGS

The present disclosure will become more readily apparent to those ordinarily skilled in the art after reviewing the following detailed description and accompanying drawings, in which:

FIG. 1A is a schematic view of a wheel of an embodiment of the present disclosure;

FIG. 1B and FIG. 1C are schematic partially enlarged views of a rim of an embodiment of the present disclosure;

FIG. 1D is a schematic cross-sectional view taken along the line A-A in FIG. 1C;

FIG. 2A and FIG. 2B are schematic partially enlarged views of a rim of another embodiment of the present disclosure;

FIG. 2C is a schematic cross-sectional view taken along the line B-B in FIG. 2B; and

FIG. 3A and FIG. 3B are schematic flow field views caused by a moving wheel in a conventional art and in an embodiment of the present disclosure, respectively.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

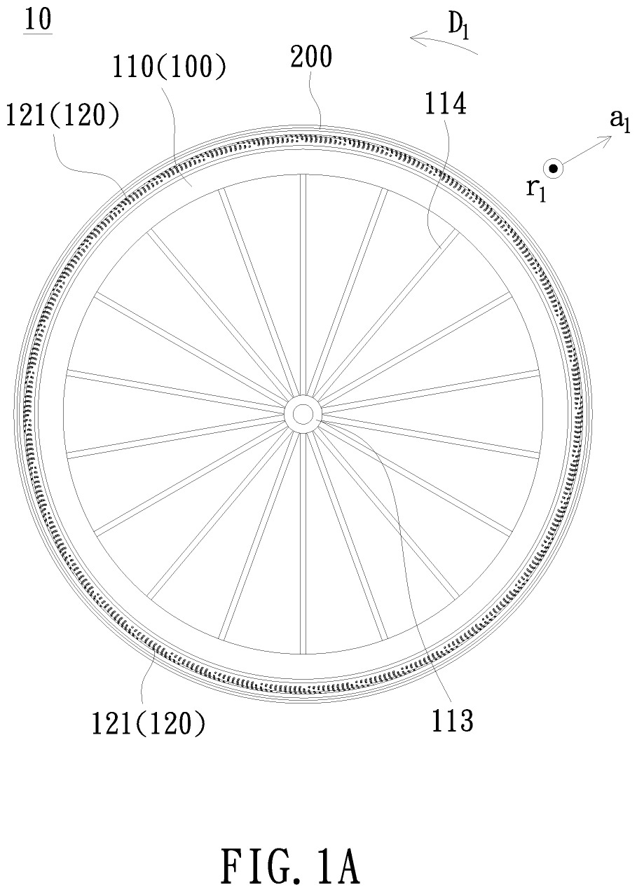

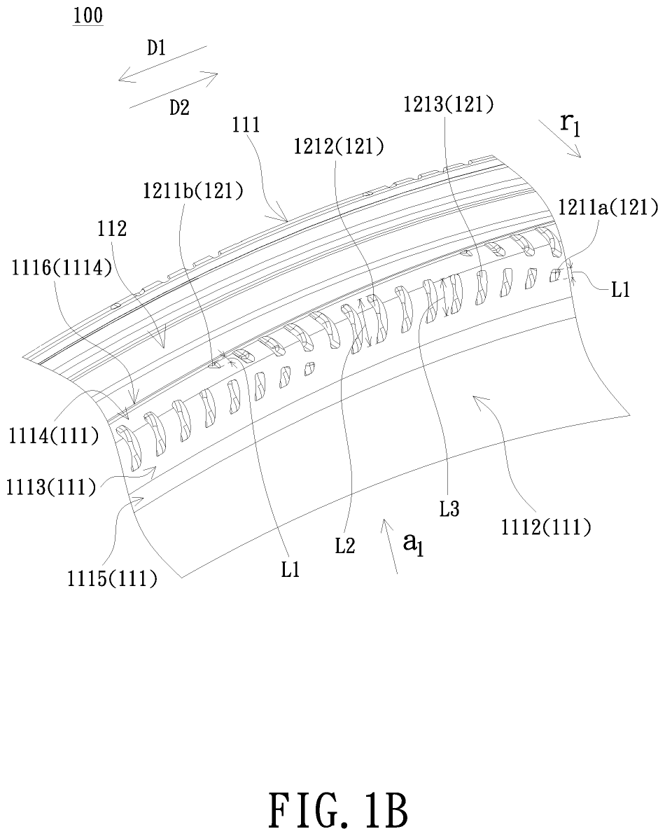

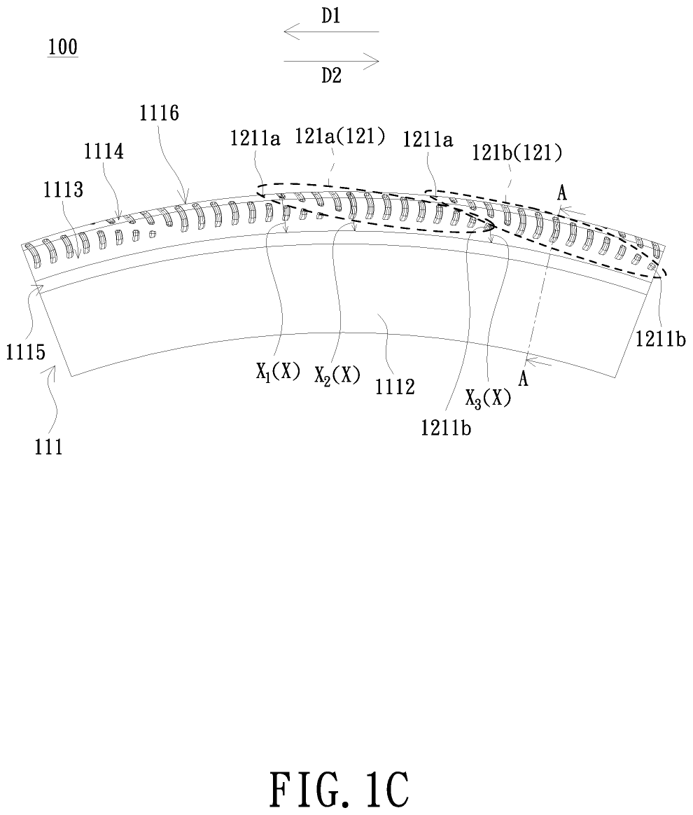

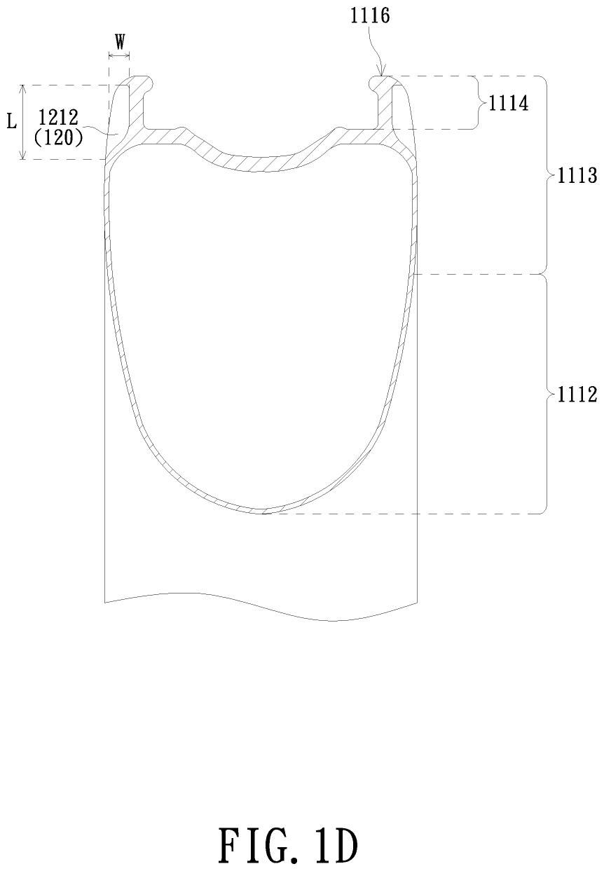

FIG. 1A is a schematic view of a wheel of an embodiment of the present disclosure. FIG. 1B and FIG. 1C are schematic partially enlarged views of a rim of an embodiment of the present disclosure. FIG. 1D is a schematic cross-sectional view taken along the line A-A in FIG. 1C. Please refer to FIG. 1A to FIG. 1D. A wheel 10 of the embodiment includes a rim 100 and a tire 200. The wheel 10 can rotate about an axis 113 along a rotating direction D1 to move a bicycle forward. The rim 100 includes a rim body 110 and a spoiler portion 120. The rim body 110 is annular and has two opposite side surfaces 111 and an intermediate portion 112 disposed between the two side surfaces 111. The intermediate portion 112 is connected to the two side surfaces 111. In general, the intermediate portion 112 can be an annular concave portion. The size of the tire 200 is fitted to the intermediate portion 112, and the wheel 10 is assembled by embedding a portion of the tire 200 into the intermediate portion 112. In addition, the rim 100 further includes a plurality of spokes 114 connected between the axis 113 and a radial inner periphery of the rim body 110.

Each of the two opposite side surfaces 111 of the rim body 110 has a radial inner portion 1112, a radial outer portion 1113 and an extension portion 1114. The radial inner portion 1112 of any of the side surfaces 111 is located on a radial inner side and gradually inclined toward the other side surface 111. One of the radial outer portions 1113 is located on a radial outer side and is substantially parallel to the other radial outer portion 1113. The radial outer portion 1113 is radially farther from the axis 113 than the radial inner portion 1112. That is, the radial outer portion 1113 is located outside the radial inner portion 1112 in the radial direction al of the axis 113. The extension portion 1114 is extended toward outside from the radial outer portion 1113 in an axis direction r1 of the axis 113, and the extension portion 1114 has a radial outer periphery 1116 on the outmost side thereof. Specifically, the extension portion 1114 is extended from one of the radial outer portions 1113 toward the other radial outer portion 1113 along the axis direction r1. The extension portion 1114 may be in contact with the tire 200 when the tire 200 is assembled to the rim 100. The spoiler portion 120 is disposed on at least one of the two side surfaces 111 and is concavely formed on the side surface 111. The spoiler portion 120 is disposed on the radial outer portion 1113, and at least a portion of the spoiler portion 120 is disposed on the extension portion 1114 without exceeding the extension portion 1114. That is, the spoiler portion 120 does not form any undulation on the radial outer periphery 1116 so as to prevent from contacting the tire 200 or damaging a tire wall of the tire 200. In the embodiment, each of the side surfaces 111 further includes a brake surface 1115 close to the radial inner portion 1112. The spoiler portion 120 is disposed on at least one of the two side surfaces 111 and is disposed between the brake surface 1115 and the radial outer periphery 1116, but is not limited thereto. For example, the brake surface 1115 can be omitted when the rim 100 is a disc-brake rim, and the spoiler portion 120 is disposed between the radial outer portion 1112 and the radial outer periphery 1116.

The spoiler portion 120 has a plurality of spoiler profiles such as the first spoiler profiles 1211a, 1211b and the third spoiler profiles 1213 to be described later. The plurality of spoiler profiles is concavely formed on the radial outer portion 1113 of at least one of the two side surfaces 111, and at least a part of the plurality of spoiler profiles is partially disposed on the extension portion 1114 without forming any undulation on the radial outer periphery 1116. In the embodiment, a portion of the spoiler portion 120 is disposed on the extension portion 1114 of each of the two side surfaces 111, but is not limited thereto.

In the embodiment as shown in FIG. 1B and FIG. 1C, the spoiler portion 120 includes a plurality of spoiler profile groups 121. Each of the plurality of spoiler profile groups 121 includes a plurality of parallelly-arranged spoiler profiles recessed from the side surface 111 toward the intermediate portion 112. The plurality of spoiler profiles includes two first spoiler profiles 1211a, 1211b respectively located at two ends, at least one second spoiler profile 1212 located in central and a plurality of third spoiler profiles 1213 located between the two first spoiler profiles 1211a, 1211b and the second spoiler profile 1212. The lengths of the plurality of third spoiler profiles 1213 are gradually changed from the two first spoiler profiles 1211a, 1211b to the second spoiler profile 1212, so that the adjacent spoiler profiles have unequal lengths in the embodiment. In addition, the plurality of spoiler profiles groups 121 is arranged parallel to each other and spaced at an equal distance.

In the embodiment, the lengths of the plurality of third spoiler profiles 1213 are gradually increased from the two first spoiler profiles 1211a, 1211b to the second spoiler profile 1212. The first spoiler profiles 1211a, 1211b have a first length L1, the second spoiler profile 1212 has a second length L2, and the third spoiler profiles 1213 have a third length L3. The second length L2 is greater than both of the first length L1 and the third length L3. The third length L3 is greater than the first length L1.

In addition, since at least a portion of the spoiler portion 120 is disposed on the extension portion 1114, one first spoiler profile 1211a of the spoiler profile group 121 is disposed on the extension portion 1114, and the other first spoiler profile 1211b is disposed on the radial outer portion 1113. In more detail, a distance X between a top of each of the plurality of spoiler profiles in the spoiler profile group 121 and the brake surface 1115 is gradually decreased from the first rotating direction D1 toward a second rotating direction D2 opposite to the first rotating direction D1. In other words, a distance between a top of each of the plurality of spoiler profiles and the radial outer periphery 1116 is gradually increased in the first rotating direction D1. The first rotating direction D1 is a direction in which the rim 100 drives the bicycle to move. In the embodiment, a first distance between a top of the first spoiler profile 1211a and the brake surface 1115 is X1, a second distance between a top of the second spoiler profile 1212 and the brake surface 1115 is X2, and a third distance between a top of the other first spoiler profile 1211b and the brake surface 1115 is X3. The first distance X1 is greater than both of the second distance X2 and the third distance X3, and the second distance X2 is greater than the third distance X3.

Please refer to FIG. 1C. Since the distance X of the top of each of the plurality of spoiler profiles in the spoiler profile group 121 and the brake surface 1115 is gradually decreased from the first rotating direction D1 toward the second rotating direction D2 opposite to the first rotating direction D1, the spoiler profile group 121a and another spoiler profile group 121b can be partially disposed on a common radial surface. In more detail, the first spoiler profile 1211b of the spoiler profile group 121a and another first spoiler profile 1211b of another spoiler profile group 121b can be disposed on a common radial surface. The first spoiler profile 1211b of the spoiler profile group 121a is closer to the brake surface 1115 than the other first spoiler profile 1211a of another spoiler profile group 121b, and the other first spoiler profile 1211a of another spoiler profile group 121b is closer to the extension portion 1114 than the first spoiler profile 1211b of the spoiler profile group 121a.

In the embodiment, not only the first spoiler profile 1211b of the spoiler profile group 121a and another first spoiler profile 1211b of another spoiler profile group 121b can be disposed on a common radial surface, a part of the third spoiler profiles 1213 of the spoiler profile group 121a and a part of the third spoiler profiles 1213 of another spoiler profile group 121b are disposed on a common radial surface.

Please refer to FIG. 1D. The spoiler portion 120 has a maximum depth W and a maximum radial length L. The maximum depth W is not less than 0.25 mm and not greater than 4.5 mm, and the maximum radial length L is not less than 0.1 mm and not greater than 300 mm. Any second spoiler profile 1212 can have both of the maximum radial length L and the maximum depth W.

According to above description, since the spoiler portion 120 is disposed on the side surface 111 of the rim 100 of the embodiment, airflow can be guided by the spoiler portion 120 when the wheel 10 rotates to reduce the possibility that a laminar boundary layer develops into a turbulent flow and reduce the air resistance experienced by the wheels 10, thereby improving riding efficiency.

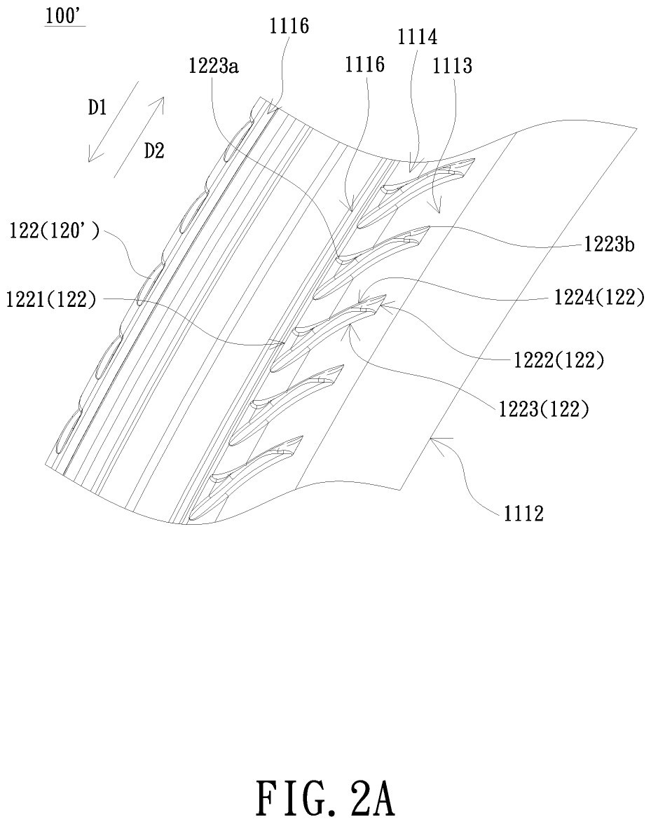

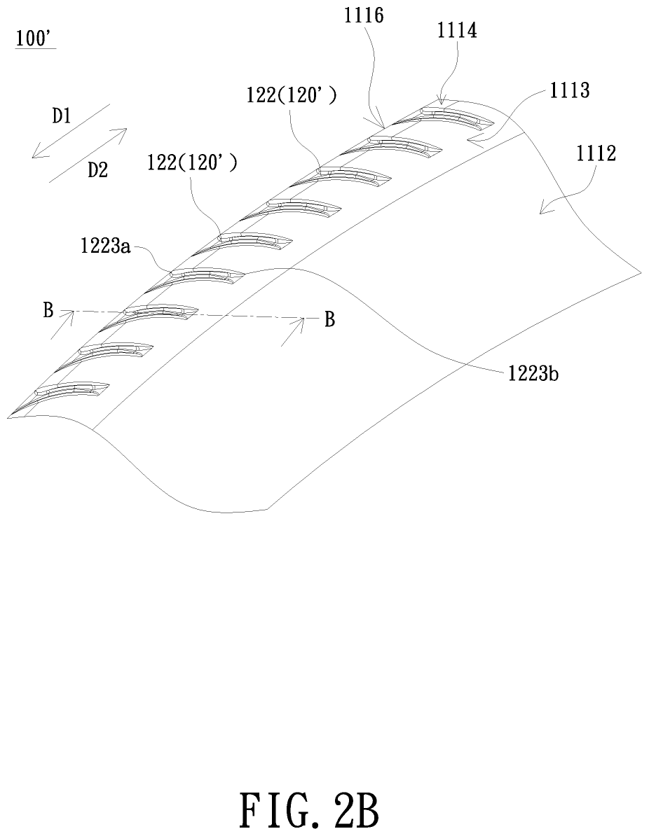

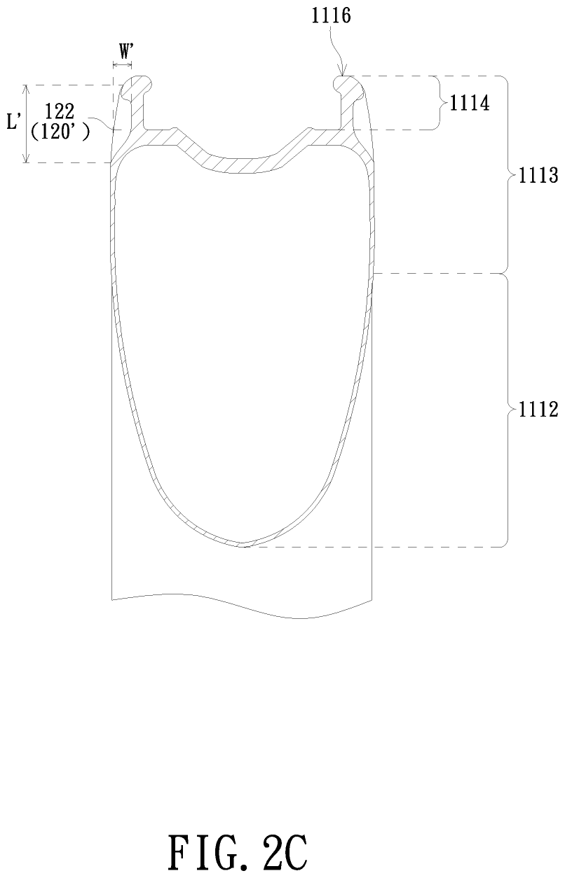

FIG. 2A and FIG. 2B are schematic partially enlarged views of a rim of another embodiment of the present disclosure. FIG. 2C is a schematic cross-sectional view taken along the line B-B in FIG. 2B. Please refer to FIG. 2A to FIG. 2C. The rim 100′ of the embodiment is substantially the same as the rim 100 of FIG. 1A, and the difference is that the spoiler portion 120′ of the rim 100′ of the embodiment includes a plurality of spoiler profiles 122 distributed at equal distances. Each of the plurality of spoiler profiles 122 is recessed from the side surface 111 toward the intermediate portion 112.

In the embodiment, each of the plurality of spoiler profiles 122 has a first opening 1221 facing the extension portion 1114 and a second opening 1222 facing the brake surface 1115. A width of the first opening 1221 is greater than a width of the second opening. 1222. Specifically, a first side wall 1223 and a second side wall 1224 opposite to the first side wall 1223 are connected between the first opening 1221 and the second opening 1222 of each of the plurality of spoiler profiles 122. For guiding airflow, the first side surface 1223 can be a smooth curved surface, and the second side surface can be a flat surface. The first side surface 1223 is extended from the first opening 1221 to the second surface 1222 along the second rotating direction D2 to form a curved surface. In more detail, a first end 1223a of the first side surface 1223 located at the first opening 1221 is disposed more toward the first rotating direction D1 than a second end 1223b located at the second opening 1222.

Please refer to FIG. 2C. The spoiler portion 120′ has a maximum depth W′ and a maximum radial length L′. The maximum depth W′ is not less than 0.25 mm and not greater than 4.5 mm, and the maximum radial length L′ is not less than 0.1 mm and not greater than 300 mm.

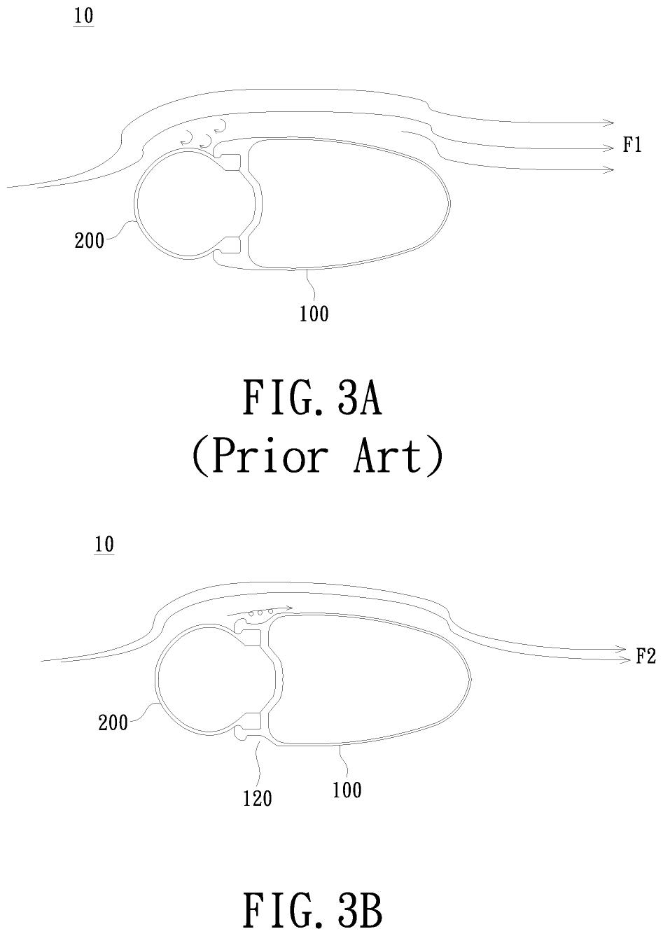

FIG. 3A and FIG. 3B are schematic flow field views caused by a moving wheel in a conventional art and in an embodiment of the present disclosure, respectively. Please refer to FIG. 3A. If the wheel 10 of FIG. 1A does not have the spoiler portion 120, airflow F1 (shown by the arc arrows) will cause backflow at the joint between the tire 200 and the rim 100 to form a dragging force on the wheel 10, thereby reducing a smoothness of the airflow F1. In contrast, because the wheel 10 of FIG. 3B has the spoiler portion 120, the backflow supposed to be occurred at the joint between the tire 200 and the rim 100 can be eliminated by the spoiler portion 120, so that the airflow F2 can be significantly smoother than the airflow F1 in FIG. 3A, therefore reducing the bearing resistance of the tire 10.

According to above description, since a spoiler portion is disposed on the side surfaces of the rim of the present disclosure, airflow can be guided by the spoiler portion when the wheel rotates to reduce the possibility that a laminar boundary layer develops into a turbulent flow and reduce the air resistance experienced by the wheels, thereby improving riding efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rim applied to a bicycle, wherein the rim rotates about an axis and comprises:
a rim body, being annular and having two opposite side surfaces, wherein the two side surfaces are connected by an intermediate portion, each of the side surfaces has a radial inner portion and a radial outer portion, the radial inner portion of one of the side surfaces is located on a radial inner side defined by a radial direction and gradually inclined toward the other side surface, and the radial outer portion is located on a radial outer side defined by the radial direction, wherein the radial outer portion has an extension portion and a radial outer periphery at the outermost side along the radial direction, and the extension portion is extended toward the radial outer side from a connecting portion between the radial outer portion and the intermediate portion; and
a spoiler portion, having a plurality of spoiler profiles concavely formed on the radial outer portion of at least one of the two side surfaces, and at least one of the plurality of spoiler profiles is partially disposed on the extension portion without forming any undulation on the radial outer periphery.

2. The rim according to claim 1, wherein a brake surface is disposed on at least one of the two side surfaces, and the spoiler portion is disposed between the brake surface and the radial outer portion.

3. The rim according to claim 1, wherein the plurality of spoiler profiles of the spoiler portion is regularly arranged as a plurality of spoiler profile groups.

4. The rim according to claim 3, wherein each of the spoiler profile groups comprises two first spoiler profiles respectively located at two ends, a second spoiler profile located in central and a plurality of third spoiler profiles located between the two first spoiler profiles and the second spoiler profile, wherein lengths of the third spoiler profiles are gradually changed from the two first spoiler profiles to the second spoiler profile.

5. The rim according to claim 4, wherein the lengths of the third spoiler profiles are gradually increased from the two first spoiler profiles to the second spoiler profile.

6. The rim according to claim 4, wherein the plurality of spoiler groups is arranged parallel to each other and spaced at an equal distance.

7. The rim according to claim 4, wherein the two first spoiler profiles are respectively disposed on a main body of the radial outer portion and the extension portion.

8. The rim according to claim 7, wherein the adjacent spoiler profiles have unequal lengths.

9. The rim according to claim 8, wherein distances between tops of the plurality of spoiler profiles and the radial outer portion are gradually increased in a rotating direction, and the rotating direction is a direction in which the rim drives the bicycle to move.

10. The rim according to claim 1, wherein the adjacent spoiler profiles have unequal lengths.

11. The rim according to claim 1, wherein the plurality of spoiler profiles is distributed at equal distances on the radial outer portion.

12. The rim according to claim 11, wherein each of the plurality of spoiler profiles has a first opening facing the extension portion and a second opening facing the radial inner portion, wherein a width of the first opening is greater than a width of the second opening.

13. The rim according to claim 12, wherein a first side wall and a second side wall opposite to the first side wall are connected between the first opening and the second opening of each of the plurality of spoiler profiles, wherein an inclination of the first side wall is smaller than an inclination of the second side wall.

14. The rim according to claim 13, wherein the first side wall has a first end on the first opening and a second end on the second opening, and the second end is disposed behind the first end in a rotating direction, and the rotating direction is a direction in which the rim drives the bicycle to move.

15. The rim according to claim 1, wherein the spoiler portion has a maximum depth not less than 0.25 mm and not greater than 4.5 mm.

16. The rim according to claim 1, wherein the spoiler portion has a maximum radial length not less than 0.1 mm and not greater than 300 mm.
